(19) United States
(12) Patent Application Publication
(10) Pub. No.: US 2007/0297647 A1
(43) Pub. Date: Dec. 27, 2007

(54) Character/text generating apparatus

(75) Inventor: Huang Hung-Chi, Taipei (TW)

Correspondence Address: BIRCH STEWART KOLASCH & BIRCH, PO BOX 747, FALLS CHURCH, VA, 22040-0747, US

(73) Assignee: COMPAL COMMUNICATIONS, INC.

(21) Appl. No.: 11/812,650

(22) Filed: Jun. 20, 2007

(30) Foreign Application Priority Data
Jun. 21, 2006 (TW) 095122221

(51) Int. Cl. G06K 9/00

(52) U.S. Cl. 382/114

(57) ABSTRACT

The invention provides a character/text generating apparatus, which includes a storage device, an image capturing device, and a processing unit. The storage stores a look-up table which records a plurality of characters or texts and a plurality of sample images. Each of the sample images corresponds to one of the characters or texts. The image capturing device captures an image relative to a posture of an operator. The processing unit, which is electrically connected to the storage device and the image capturing device, respectively, receives the captured image, compares the captured image with the sample images stored in the look-up table to determine one from the sample images, and accesses one of the characters or texts from the storage device according to the determined sample image.

### BACKGROUND OF THE INVENTION

1. Field of the Invention

This present invention relates to a character/text generating apparatus, and more particularly, relates to a character/text generating apparatus capturing an image relative to a posture.

2. Description of the Prior Art

Currently, a mobile communication apparatus, such as a mobile phone, a personal digital assistant (PDA), and so on, has a keypad for an operator to input characters needed. However, the number of the keys offered by an apparatus like this is limited. Characters can be inputted not by one-to-one manner but by selecting in groups, which is inconvenient for the operator. For example, as shown in FIG. 1, for a conventional keypad, when a character “z” is to be inputted, the operator needs to press the number key “9” for four times. If the operator unmindfully presses once more, the operator needs to press for three times additionally, which is inconvenient for the operator and elongates the input time. Based on the development trend of the mobile communication apparatus at present, an image capturing device will be a standard accessory for a mobile communication apparatus. If the uniqueness and variousness of image could be utilized with the image capturing device, a one-to-one input can be established so as to avoid the problems mentioned above.

Accordingly, the invention provides a character/text generating apparatus capturing an image relative to a posture so as to solve the problems mentioned above.

### SUMMARY OF THE INVENTION

One scope of the invention is to provide a character/text generating apparatus. An operator can complete the input of a character or a text by capturing an image relative to a posture of the operator.

According to a preferred embodiment of the invention, the character/text generating apparatus includes a storage device, an image capturing device, and a processing unit. The storage device stores a look-up table, which records a plurality of characters or texts and a plurality of sample images. Each of the sample images corresponds to one of the characters or texts. The image capturing device is configured to capture an image of a posture of an operator. The processing unit is electrically connected to the storage device and the image capturing device, respectively. The processing unit is configured to receive the captured image, access the sample images, determine one from the sample images by comparing the captured image with the sample images, and access one of the characters or texts from the storage device according to the determined sample image.

In addition, the character/text generating apparatus is embedded in a data processing system. The data processing system includes a display. The image capturing device is disposed on the display. The data processing system also includes a processor. The processing unit and the processor are the same. The processing unit outputs the accessed character or text to the display so as to display the accessed character or text on the display. Furthermore, the image capturing device is operated by the processing unit to capture an image relative to the operator at a time interval.

Therefore, according to the preferred embodiment of the invention, the character/text generating apparatus compares the image of the posture relative to the operator with the sample images, so as to determine the corresponding input character or text.

The advantage and spirit of the invention may be understood by the following recitations together with the appended drawings.

### BRIEF DESCRIPTION OF THE APPENDED DRAWINGS

FIG. 1 is a sketch diagram illustrating a keypad according to an embodiment of the prior art.

FIG. 2 is a function block diagram according to a preferred embodiment of the invention.

FIG. 3 is a sketch diagram illustrating a portion of a look-up table according to the preferred embodiment.

FIG. 4A is a sketch diagram illustrating an application according to an embodiment.

FIG. 4B is a sketch diagram illustrating an application according to another embodiment.

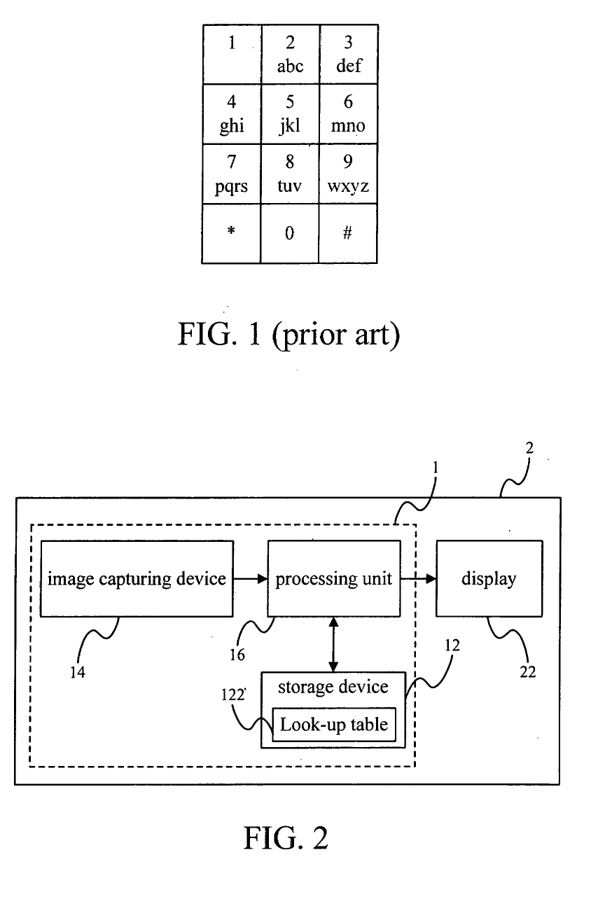

### DETAILED DESCRIPTION OF THE INVENTION

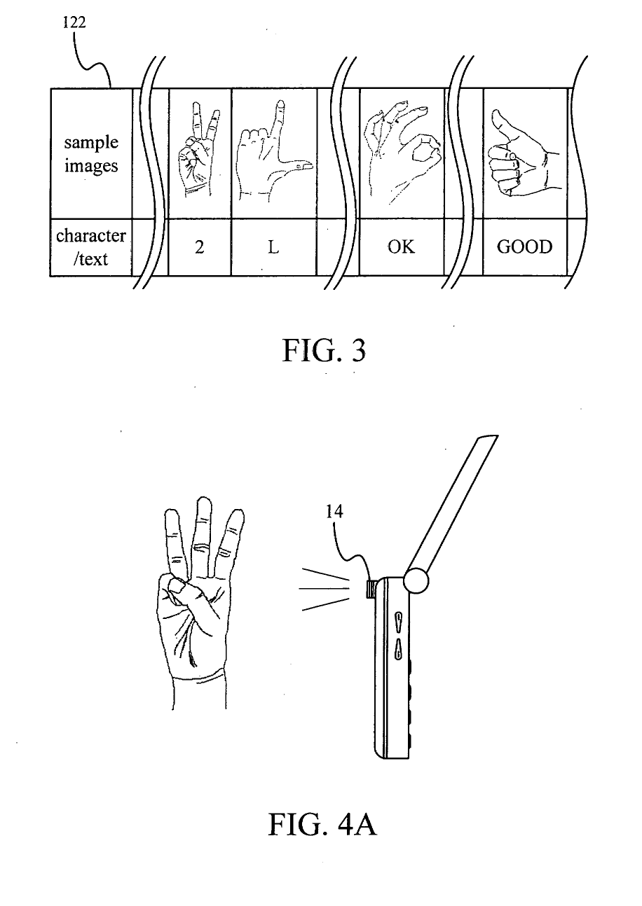

Please refer to FIGS. 2 and 3. FIG. 2 is a function block diagram according to a preferred embodiment of the invention. FIG. 3 is a sketch diagram illustrating a portion of a look-up table according to the preferred embodiment. According to the preferred embodiment, a character/text generating apparatus 1 of the invention includes a storage device 12, an image capturing device 14, and a processing unit 16. The processing unit 16 is electrically connected to the storage device 12 and the image capturing device 14, respectively. Furthermore, the character/text generating apparatus 1 is embedded in a data processing system 2 which includes a display 22 and a processor 16. According to the preferred embodiment, the processor 16 and the processing unit 16 are the same. The display 22 is electrically connected to the processing unit 16.

Furthermore, the storage device 12 stores a look-up table 122 recording a plurality of characters or texts and a plurality of sample images. Each of the sample images corresponds to one of the characters or texts. The image capturing device 14 is able to capture an image of a posture relative to an operator.

Therefore, the processing unit 16 is configured to receive the captured image, access the sample images, determine one from the sample images by comparing the captured image with the sample images, and access one of the characters or texts from the storage device 12 according to the determined sample image. Furthermore, the processing unit 16 outputs the accessed character or text to the display 22 so as to display the accessed character or text on the display 22.

For example, when the posture of the operator matches the fourth sample image of the look-up table 122 shown in FIG. 3, the processing unit 16 accesses the corresponding text “GOOD” to the display 22 so as to display the text “GOOD”. Similarly, when the posture of the operator matches the second sample image of the look-up table 122 shown in FIG. 3, the processing unit 16 accesses the corresponding character “L” to the display 22 so as to display the character “L”.

Furthermore, the characters or texts recorded in the look-up table 122 can be modified arbitrarily. Similarly, the sample images can also be added, modified, or deleted arbitrarily. Therefore, the operator can reduce the time for inputting specific texts by adding or modifying the sample images, which enhances the practicality of the character/text generating apparatus 1.

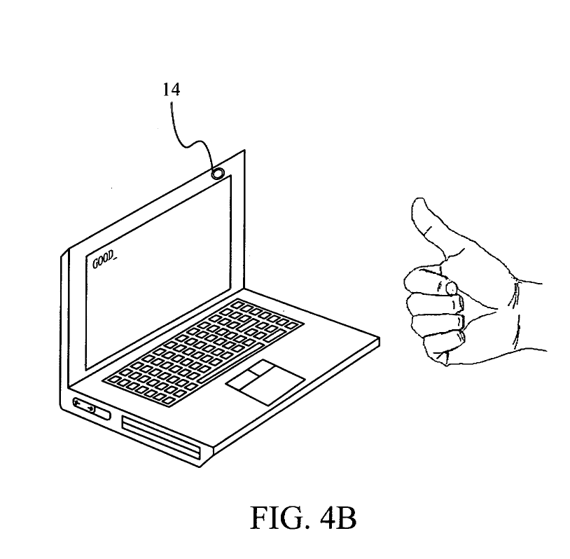

In addition, in order to apply the character/text generating apparatus of the invention to different products, the installation of the image capturing device 14 varies for the different products. For example, as shown in FIGS. 4A and 4B, the image capturing device 14 can be installed on the front or the rear of a cellular phone or a PDA. The image capturing device 14 can also be installed beside the monitor of a notebook or be externally installed beside the monitor of a desktop computer or other proper position.

Furthermore, the image capturing device 14 is operated by the processing unit 16 to capture an image of the posture relative to the operator at a time interval or by a control button. The control button can be one of the original key of the keypad or an additional private key.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A character/text generating apparatus, comprising:
a storage device for storing a look-up table, the look-up table recording a plurality of characters or texts and a plurality of sample images, each of the sample images corresponding to one of the characters or texts;
an image capturing device for capturing an image relative to a posture of an operator; and
a processing unit electrically connected to the storage device and the image capturing device, respectively, wherein the processing unit receives the captured image, accesses the sample images, determines one from the sample images by comparing the captured image with the sample images, and accesses one of the characters or texts from the storage device according to the determined sample image.

2. The character/text generating apparatus of claim 1, wherein the character/text generating apparatus is embedded in a data processing system comprising a display, and the image capturing device is disposed on the display.

3. The character/text generating apparatus of claim 2, wherein the data processing system also comprises a processor, and the processing unit and the processor are the same.

4. The character/text generating apparatus of claim 2, wherein the processing unit outputs the accessed character or text to the display so as to display the accessed character or text on the display.

5. The character/text generating apparatus of claim 1, wherein the image capturing device is operated by the processing unit to capture an image of the posture of the operator at a time interval.
